(19) United States
(12) Patent Application Publication
(10) Pub. No.: US 2023/0177469 A1
(43) Pub. Date: Jun. 8, 2023

(54) TECHNIQUES FOR SEGMENTING USERS BASED ON USER BEHAVIORS ACROSS ELECTRONIC COMMUNICATION CHANNELS

(71) Applicant: Iterable, Inc., San Francisco, CA (US)

(72) Inventors: Ankit AWASTHI, San Francisco, CA (US); Ayush AGARWAL, San Francisco, CA (US); Steven LY, San Francisco, CA (US); Praateek MAHAJAN, San Francisco, CA (US); Wayne COBURN, El Cerrito, CA (US)

(21) Appl. No.: 17/544,340

(22) Filed: Dec. 7, 2021

(51) Int. Cl. G06Q 10/10; H04L 67/50; G06F 9/54

(52) U.S. Cl. CPC G06Q 10/107; H04L 67/22; G06F 9/542

(57) ABSTRACT

Techniques are disclosed for segmenting users based on user interactions with messages transmitted over various electronic communication channels. In some embodiments, a segmentation application normalizes sets of event data associated with user interactions with messages that are transmitted over multiple electronic communication channels to generate intermediate labels associated with the sets of event data. The normalization includes applying a time decay while accounting for messaging cadence, messaging volume, and user interactions with messages associated with an industry. The intermediate labels are combined to generate a final label associated with the user via a pairwise combination technique that maintains a more favorable label when a pair of intermediate labels are combined. Additional messages can then be generated and/or transmitted based on the final label.

### BACKGROUND

### Technical Field

Embodiments of the present disclosure relate generally to computer science and computer networking and, more specifically, to techniques for segmenting users based on user behaviors across electronic communication channels.

### Description of the Related Art

Automated message campaigns are used to send electronic messages to a large numbers of users. Oftentimes, multiple message campaigns are used to send messages to the same users across different electronic communication channels, such as email, text message, in-application notification, push notification, web push notification, and the like.

In order to send customized messages to users, the users should be segmented into groups that are each targeted with a different message. Few, if any, current techniques exist for segmenting users that account for messages sent across multiple electronic communication channels to those users and user interactions with those messages.

As a general matter, data associated with messages that are sent to users across multiple electronic communication channels and user interactions with those messages can be in disparate formats that are not easily reconcilable. For example, the messages could be sent across multiple electronic communication channels, with different time intervals between messages that are sent over each electronic communication channel. As another example, the users could interact with the messages in different ways, such as by opening the messages, by viewing the messages, by clicking on hyperlinks in the messages, etc. Accordingly, data associated with messages that are sent to users over multiple electronic communication channels and user interactions with those messages are oftentimes in disparate formats that cannot be readily used together to segment the users into groups for targeted messaging.

As the foregoing illustrates, what is needed in the art are techniques for segmenting users who receive messages across different electronic communication channels.

### SUMMARY

One embodiment provides a computer-implemented method. The method includes transmitting a plurality of messages to a user via an electronic communication channel. The method further includes storing one or more events associated with one or more interactions of the user with the plurality of messages. In addition, the method includes generating a label based on the one or more events, where generating the label comprises performing one or more normalization operations based on the one or more events, a time decay, and a time interval between transmission of consecutive messages in the plurality of messages.

Further embodiments include non-transitory computer-readable storage media storing instructions that, when executed by a computer system, cause the computer system to perform the methods set forth above, and computer systems programmed to carry out the methods set forth above.

One advantage of the techniques disclosed herein is that the disclosed techniques normalize disparate forms of data associated with user interactions with messages that are transmitted over multiple electronic communication channels. The normalization permits users to be segmented into groups, without penalizing the number or type of electronic communication channels over which the messages are transmitted. In addition to being agnostic to the electronic communication channels that are used to transmit messages, the disclosed techniques are scalable when the number of electronic communication channels over which messages are transmitted increases. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a conceptual illustration of a system configured to implement one or more embodiments;

FIG. 2 illustrates an exemplar computing system, according to various embodiments;

FIG. 3 illustrates the segmentation application of FIGS. 1-2 in greater detail, according to various embodiments;

FIG. 4 illustrates a flow diagram of method steps for assigning a label to a user, according to various embodiments;

FIG. 5 illustrates a flow diagram of method steps for normalizing a set of events, according to various embodiments; and

FIG. 6 illustrates a flow diagram of method steps for generating a final label based on intermediate labels, according to various embodiments.

### DETAILED DESCRIPTION

In the following description, numerous specific details are set forth to provide a more thorough understanding of the present disclosure. However, it will be apparent to one of skilled in the art that the present disclosure may be practiced without one or more of these specific details.

### System Overview

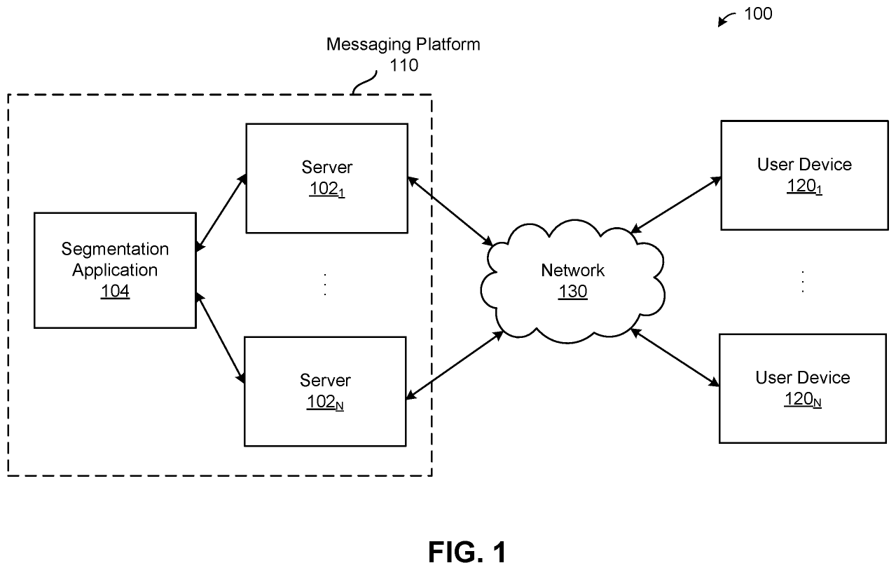

FIG. 1 is a conceptual illustration of a system 100 configured to implement one or more embodiments. As shown, the system 100 includes, without limitation, a messaging platform 110 that transmits electronic messages over a network 130 to a number of user devices 120_{1-N} (referred to herein collective as user devices 120 and individually as a user device 120). In some embodiments, the messages can include text messages, emails, in-application notifications, push notifications, web push notifications, and/or the like that are associated with one or more electronic communication channels (text messaging, email, etc.). The messages can be transmitted to the user devices 120 over any technically feasible network 130 (or networks), such as the Internet.

As shown, the messaging platform 110 includes a number of servers 102_{1-N} (referred to herein collective as servers 102 and individually as a server 102) that generate and transmit electronic messages. Each server 102 can generate and transmit messages over one or multiple electronic communication channels. Illustratively, the servers 102 are in communication, via a network (not shown), with a segmentation application 104 that generates labels to segment users based on user behaviors across electronic communication channels that are logged (i.e., stored) by the servers 102. In some embodiments, functionality of the servers 102 and the segmentation application 104 can be implemented in any technically feasible manner, including across any number of pieces of software that run on any number of computing systems. For example, in some embodiments, one or more of the servers 102 and/or the segmentation application 104 can be implemented in any type of virtual computing system, distributed computing system, or cloud computing environment, such as a public cloud, a private cloud, or a hybrid cloud.

Messages that are generated by servers 102 can include any suitable content. For example, the servers 102 could generate messages as part of message campaigns that target a large number of users. To generate a message, a server 102 can retrieve information from one or more data sources to include in the message. After generating a message, the server 102 (or other server(s)) can send that message to a user device 120. In some embodiments, the server 102 (or other server(s)) logs (1) a send event when a message is sent to a user device 120, and (2) events associated with interactions by the user with the message via the user device 120. For example, each message could be associated with an identifier (ID), and the server 102 can record, in a log, a send event that includes the message ID, an open event that includes the message ID and a timestamp when the user opens the message, and/or a hyperlink clicked event that includes the message ID and a timestamp when the user clicks or otherwise activates a hyperlink within the message, etc. The server 102 can identify the message opens, clicks on the hyperlinks, etc. in any technically feasible manner, including using well-known techniques.

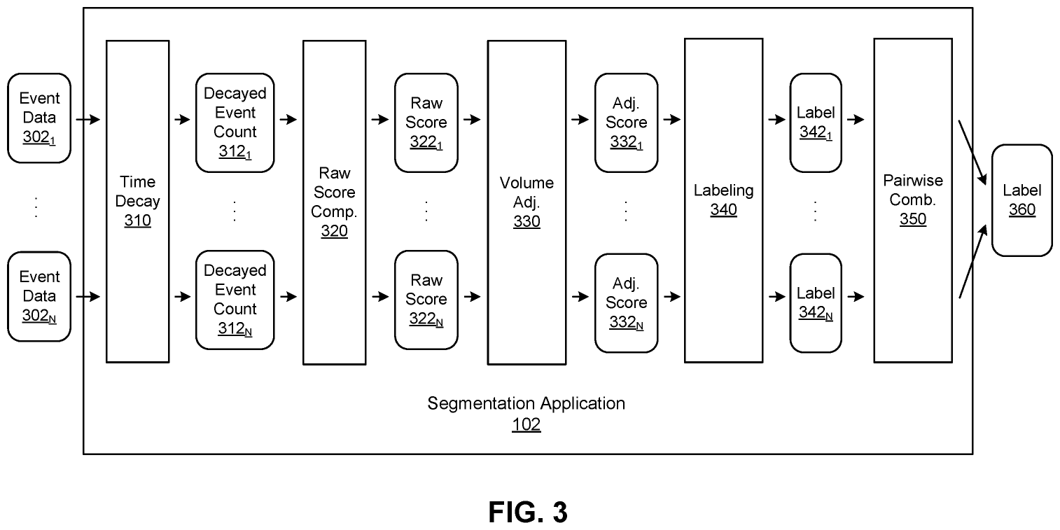

The segmentation application 104 assigns labels to users based on interactions by those users with messages that are transmitted over multiple electronic communication channels, thereby segmenting those users. In some embodiments, the segmentation application 104 (1) normalizes sets of event data that are logged by the servers 120 for each user to generate intermediate labels associated with different electronic communication channels, and (2) combines the intermediate labels to generate a final label associated with the user, as discussed in greater detail below in conjunction with FIGS. 3-6.

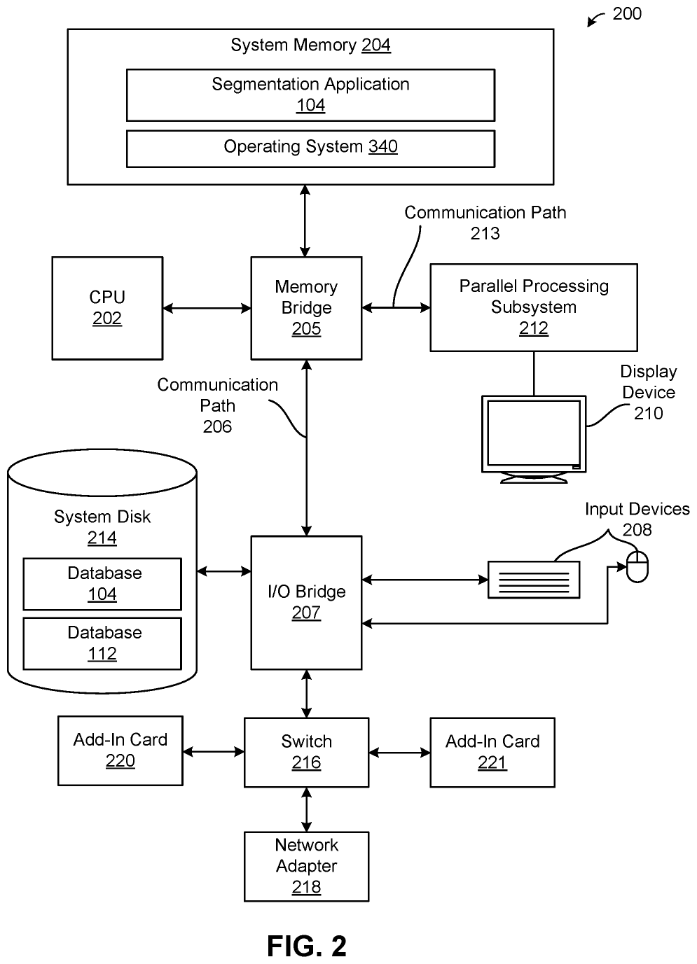

FIG. 2 illustrates an exemplar computing device 200, according to one or more embodiments. As shown, the computing device 200 includes, without limitation, a central processing unit (CPU) 202 and a system memory 204 coupled to a parallel processing subsystem 212 via a memory bridge 205 and a communication path 213. The memory bridge 204 is further coupled to an I/O (input/output) bridge 207 via a communication path 206, and the I/O bridge 207 is, in turn, coupled to a switch 216.

In operation, the I/O bridge 207 is configured to receive user input information from input devices 208, such as a keyboard or a mouse, and forward the input information to the CPU 202 for processing via the communication path 106 and the memory bridge 205. The switch 216 is configured to provide connections between the I/O bridge 207 and other components of the computer system 200, such as a network adapter 218 and various add-in cards 220 and 221.

As also shown, the I/O bridge 207 is coupled to a system disk 214 that may be configured to store content and applications and data for use by CPU 202 and parallel processing subsystem 212. As a general matter, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Illustratively, the system disk 214 stores the databases 104 and 112. In some embodiments, one or both of the databases 104 and 112 can be stored elsewhere, such as in other storage device(s) or across multiple computing devices. Finally, although not explicitly shown, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, communication paths 206 and 213, as well as other communication paths within the client device 102, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to a display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs) included within the parallel processing subsystem 212. In other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and compute processing operations. The system memory 104 includes at least one device driver 103 configured to manage the processing operations of the one or more PPUs within the parallel processing subsystem 212.

In various embodiments, the parallel processing subsystem 212 may be integrated with one or more of the other elements of FIG. 2 to form a single system. For example, the parallel processing subsystem 212 may be integrated with the CPU 202 and other connection circuitry on a single chip to form a system on chip (SoC).

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, the system memory 204 could be connected to CPU 202 directly rather than through memory bridge 205, and other devices would communicate with the system memory 204 via the memory bridge 205 and the CPU 202. In other alternative topologies, the parallel processing subsystem 212 may be connected to the I/O bridge 207 or directly to the CPU 202, rather than to the memory bridge 205. In still other embodiments, the I/O bridge 207 and the memory bridge 205 may be integrated into a single chip instead of existing as one or more discrete devices. Lastly, in certain embodiments, one or more components shown in FIG. 2 may not be present. For example, the switch 216 could be eliminated, and the network adapter 218 and add-in cards 220, 221 would connect directly to the I/O bridge 207.

Illustratively, the system memory 204 stores the segmentation application 104. In addition, the system memory 216 stores an operating system 240 which can be, e.g., Linux® or Microsoft Windows®. In some embodiments, the segmentation application 104 is configured to segment users based on user interactions with messages that are transmitted over various electronic communication channels, as discussed in greater detail below in conjunction with FIGS. 3-6.

In alternate embodiments, the system 200 may include any amount of memory 204, and any number of processors 202 that are implemented in any technically feasible fashion. Further, the memory 204 and the processor 202 may be implemented via any number of physical resources located in any number of physical locations. For example, the memory 204 and the processor 202 could be included in one or more computing systems that provide a cloud computing environment or a distributed computing environment. The connection topology between the various units in FIGS. 1 and 2 may also be modified as desired.

### Segmenting Users Based on User Behaviors Across Electronic Communication Channels

FIG. 3 illustrates the segmentation application 104 of FIGS. 1-2 in greater detail, according to various embodiments. As shown, for a given user, the segmentation application 104 takes as inputs sets of event data 302_{1-N} (referred to herein collectively as sets of event data 302 and individually as a set of event data 302) that are associated with different types of events. In some embodiments, events that are included in the sets of event data 302 can include the user opening or otherwise interacting with an electronic message. Examples of such events include the user opening an email, viewing a text message, viewing an in-application notification, viewing a push notification, viewing a web push notification, activating a hyperlink within a message, and the like. In some embodiments, the sets of event data 302 correspond to messages associated with a particular brand that are sent a user, and the segmentation application 104 uses the sets of event data 302 to generate a label that indicates an affinity of that user for the brand. The brand can be associated with an entity (e.g., a company or individual), a product, and/or a service.

Event data, such as the sets of event data 302, are oftentimes in disparate formats that cannot be readily used to segment users into groups for targeted messaging. For example, one set of event data 302 could be associated with opening emails that are sent to a user with a particular cadence (e.g., once a week), another set of event data 302 could be associated with the user clicking on links in those emails, another set of event data 302 could be associated with the user viewing text messages that are sent to the user with a different cadence (e.g., once a month), etc. In order to use the disparate sets of event data 302 together, the segmentation application 104 normalizes the sets of event data 302 to generate intermediate labels 342_{1-N} (referred to herein collectively as intermediate labels 342 and individually as an intermediate label 342) corresponding to the sets of event data 302. It should be noted that the intermediate labels 342 can be agnostic to the electronic communication channel used to transmit the messages. The segmentation application 104 combines the intermediate labels 342 to generate a final label 360 for the user. Continuing the brand affinity example, the sets of event data 302 for a user can be normalized to generate intermediate labels 342, such as “loyal,” “positive,” “neutral,” and “negative,” that are indicative of brand affinity based on different sets of event data 302, and the intermediate labels 342 can be combined to generate the final label 360 that is indicative of brand affinity of the user.

As shown, the sets of event data 302 are normalized to generate the intermediate labels 342 by (1) applying, via a time decay module 310, a time decay that accounts for the cadence with which messages are sent to the user in order to obtain, for each set of event data 302, a decayed count of events 312_{1-N} (referred to herein collectively as decayed event counts 312 and individually as a decayed event count 312); (2) computing, via a raw score computation module 320, raw scores 322_{1-N} (referred to herein collectively as raw scores 322 and individually as a raw score 322) based on the decayed event counts 312; (3) adjusting, via a volume adjustment module 330, the raw scores 322 to generate adjusted scores 332_{1-N} (referred to herein collectively as adjusted scores 332 and individually as an adjusted score 332) that account for the volume of messages that are sent to the user; and (4) converting, via a labeling module 340, the adjusted scores 332 into the intermediate labels 342 while accounting for user interactions with messages associated with an industry. Such a normalization converts the sets of event data 302, which can be in disparate formats, to a common label format that is agnostic to the electronic communication channels used to transmit the messages associated with the sets of event data 302.

The time decay module 310 applies a time decay to account for recency bias. Continuing the brand affinity example, recent user behaviors can provide a better indication of the current affinity of a user towards a brand than older user behaviors. In some embodiments, for an event e that occurred at a particular time having timestamp T, the time decay module 310 assigns a weight to the event as follows:

wₑ=d^{b}(T)

where b(T)=floor((T₀−T)/ [symbol] ), d is constant decay weight, 0<d<1, T₀ is the current timestamp, and [symbol] a decay interval. It should be understood that some messages may be sent to users more frequently than other messages. To account for the cadence with which messages are sent so that the intermediate labels 342 are not biased by the frequency with which messages are sent, the decay interval [symbol] can be set to be an average time, across users, between messages that are sent. Continuing the brand affinity example, assume that more than ten messages associated with a particular brand have been sent to a number of users over a particular electronic communication channel. In such a case, the decay internal [symbol] for events associated with those messages can be an average time, across those users, between the first and tenth messages. It should be noted that such a time decay is not based on the messages. Instead, the time decay is based on time, but the rate of decay accounts for the message cadence.

Using weights for each event that are computed according to equation (1), the time decay module 310 computes a decayed count of all occurrences of each event, shown as a decayed event count 312, according to the following summation:

Decayed Count=Σwₑ (2),

In equation 2, the weights for each event in a set of event data 302 are added together to obtain the decayed event count 312.

The raw score computation module 320 takes the decayed event counts 312 as inputs and outputs corresponding raw scores 322. In some embodiments, the raw score computation module 320 computes a raw score 322 by dividing the corresponding decayed event count 312 by a decayed count of the number of messages associated with the events that are sent:

raw_score=decayed count of events/decayed count of message sends. (3)

The decayed count of the number of messages can be computed, similar to equation (2), by using a time decay that accounts for message cadence.

Some events may not be associated with messages that are sent. For example, in-application opens by a user are generally not associated with any messages being sent. In some embodiments, a raw score 322 for a set of event data that is not associated with any messages is set to the corresponding decayed event count 312, rather than being computed according to equation (3).

The volume adjustment module 330 takes the raw scores 322 as inputs and outputs corresponding adjusted scores 332 that account for the volume of messages sent to the user. Continuing the brand affinity example, the raw score computed according to equation (3) for a user who opens 2 out of 2 emails would be the same as the raw score for a user who opens 10 out of 10 emails. However, intuitively, a higher brand affinity should be assigned to the user who opens 10 out of 10 emails. To adjust the raw score for the volume of messages sent to a user, the volume adjustment module 330 computes the adjusted scores 332 by weighting each raw score 322 by a boosting factor that boosts the raw score 322 if the number of events associated with the user is higher relative to a median number of events:

adjusted_score=raw_score*boosting_factor. (4)

In some embodiments, the boosting factor can be computed as follows:

boosting_factor=max(Ib, min(ub, (number of events in last month/median number of events in last month)), (5)

where lb and ub are a lower bound and an upper bound on the boosting factor, respectively. For example, in some embodiments, lb and ub can be 1 and 2, respectively. In some embodiments, the boosting factor of equation (5) considers only recent activity (e.g., within the last month or any other technically feasible period of time) and compares the number of recent events associated with the user to the median number of recent event across a number of users (e.g., all users).

The labeling module 340 takes the adjusted scores 332 as inputs and outputs the corresponding intermediate labels 342. In some embodiments, the labeling module 340 converts the adjusted scores 332 into the intermediate labels 342 based on a histogram of adjusted scores for a given industry. Continuing the brand affinity example, messages from brands associated with different industries can elicit different user behaviors. Accordingly, in some embodiments, a histogram of adjusted scores can be constructed across brands for a given industry, and a label can be assigned based on the adjusted score 332 and the histogram, with the following label populations: negative: 10%, neutral: 40%, positive: 40%, loyal: 10%. Other labels and label proportions can be used in some embodiments. It should be noted that, although the proportions for each label are predefined, for any given brand, the label populations can vary depending on the adjust scores for messages associated with that brand. The variability of label populations differs from techniques that simply rank users and assign particular labels (e.g., “loyal”) to certain percentages of users, because the label populations do not change with such techniques. Continuing the brand affinity example, only if the population of “negative,” “neutral,” “positive,” and “loyal” users changes over time can the effectiveness of message campaigns in promoting affinity with a brand be measured.

In some embodiments, users who are not associated with a minimum number of events are assigned a default label, such as unscored, rather than a label according to label proportions, described above. For example, the minimum number of events could be three.

In some embodiments, the labeling module 340 can also assign intermediate labels based on custom events that are unrelated to messages sent to a user. Continuing the brand affinity example, a monthly subscription by a user could be considered a custom event that indicates the user is loyal to a particular brand. In such a case, the label population for the monthly subscription custom event could be negative: 0%, neutral: 0%, positive: 0%, loyal: 100%. As another example, a user could send transactional emails, and the number of send events for transactional emails can be a positive indicator of brand affinity that is used to assign an intermediate label. As further examples, page (e.g., webpage) views, product views, adding to a cart, making purchases, playing media content items (e.g., a song, a video, etc.), etc. could be custom events that are used to assign intermediate labels. More generally, the labeling module 340 can assign any suitable intermediate labels based on any technically feasible events, in any technically feasible manner. In addition, the segmentation application 104 can receive data associated with custom events and/or specifications of how to assign labels to custom events in any technically feasible manner, such as via an application programming interface (API) from servers other than the servers 102 (e.g., servers of entities associated with various brands in the brand affinity example).

After the intermediate labels 342 are assigned, the pairwise combination module 350 combines the intermediate labels 342 across events, in a pairwise manner, into the final label 360. In some embodiments, the pairwise combination of intermediate labels 342 includes assigning a score to each intermediate label 342, computing a combined label score by adding a pair of intermediate label scores together, determining a combined intermediate label based on the sum of the pair of intermediate label scores, computing another combined label score based on a label score associated with the combined intermediate label and a label score associated with another intermediate label, etc., until the final label 360 is obtained. Such a pairwise combination is associative, meaning the intermediate labels 342 can be combined in any order. Returning to the brand affinity example, two event affinity labels could be combined at a time, and the combination can be performed hierarchically with the following scores for each label: negative=1, neutral=3, positive=7, loyal=11, unscored=0. In such a case, the combined score for a pair of intermediate labels can be set to combined label score=label score_1+label score 2, and the combined label score can be converted to a combined label as follows: combined label score>=11→loyal, combined_label_score>=7→positive, combined_label_score>=3→neutral, combined_label_score<3→negative. Using such a combination, if a given user is assigned a “loyal” label based on any set of event data 302, then a combined label (and the final label 360) for the user will still be “loyal.” For example, a user that is highly engaged with email messages associated with a particular brand will be assigned the “loyal” label even if the user is not engaged with text messages associated with the brand.

Once generated, the final label 360 can be used in any technically feasible manner. In some embodiments, the final label 360 can be added to a profile of the user that is stored in a database and displayed to a sender of the messages (e.g., a sender of messages associated with a particular brand). In some embodiments, the final label 360 can be used to generate new messages to send to the user, to determine which messages to send to the user, and the like. Continuing the brand affinity example, the final label 360 could be used to generate new messages that the user might be interested in if the user is “loyal,” “positive,” or “neutral” towards a brand. As another example, the final label 360 could be used to generate promotional messages for users that are “loyal” to a brand.

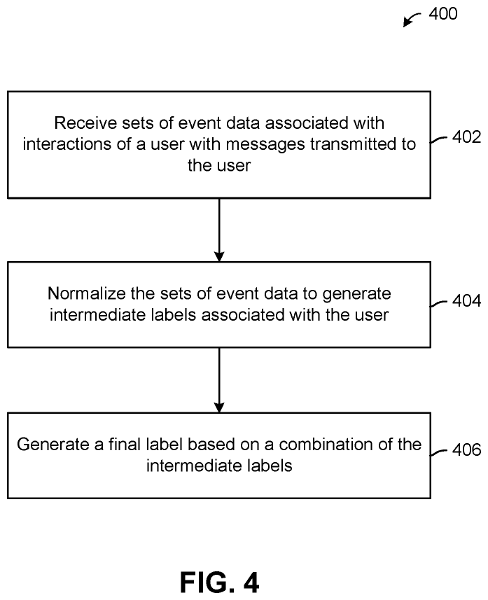

FIG. 4 illustrates a flow diagram of method steps for assigning a label to a user, according to various embodiments. Although the method steps are described in conjunction with the systems of FIGS. 1-3, persons of ordinary skill in the art will understand that any system configured to perform the method steps, in any order, is within the scope of the present disclosure.

As shown, a method 400 begins at step 402, where the segmentation application 104 receives sets of event data (e.g., sets of event data 302) associated with interactions of a user with messages transmitted to the user. As described, the messages can be transmitted to the user via one or multiple electronic communication channels. User interactions with the messages, such as opening the messages, clicking on links within the messages, etc. can then be logged as the sets of event data. In some embodiments, the event data logs can be cleaned in any technically feasible manner to remove noisy data. For example, multiple open events that are associated with the same message within a short period of time could be reduced to a single open event.

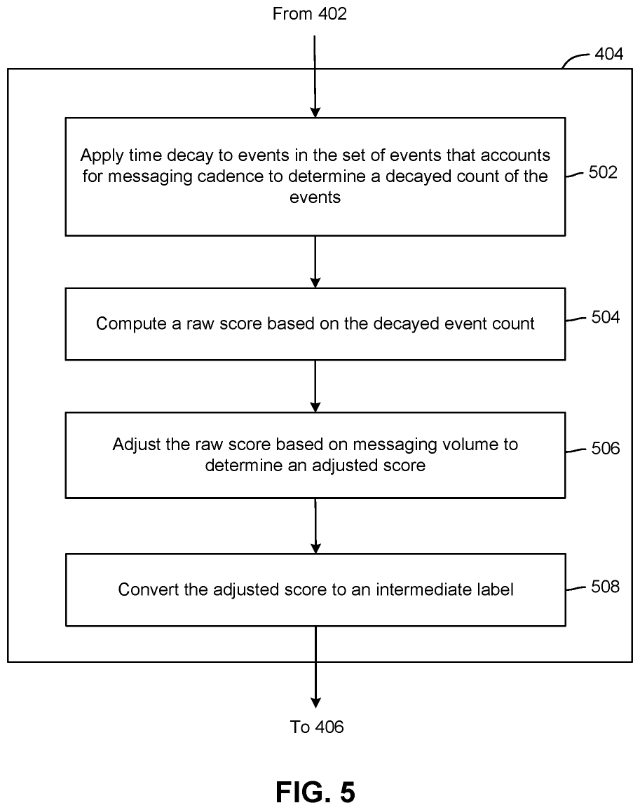

At step 404, the segmentation application 104 normalizes the sets of event data to generate the intermediate labels (e.g., labels 304) associated with the user. In some embodiments, the segmentation application 104 normalizes a set of event data by (1) applying a time decay to determine a decayed count of events that accounts for messaging cadence, (2) computing a raw score, (3) adjusting the raw score to account for messaging volume, and (4) converting the adjusted score to an intermediate label while accounting for user interactions with messages associated with an industry, as discussed in greater detail below in conjunction with FIG. 5. The normalization at step 404 permits event data, which is oftentimes in disparate formats, to be used together to generate a final label. In some embodiments, the segmentation application 104 can also assign intermediate labels based on events that are not associated with messages, such as in-application opens. In such cases, the raw score for a set of event data that is not associated with messages can be set to a decayed event count, and an intermediate label can be computed based on the raw score in a similar manner to the computation for events that are associated with messages, as described above in conjunction with FIG. 3. In some embodiments, the segmentation application 104 can also assign intermediate labels based on custom events in any technically feasible manner, as described above in conjunction with FIG. 3. As described, examples of custom events include subscriptions, transactional emails, page views, product views, adding to a cart, making purchases, playing media content items, etc.

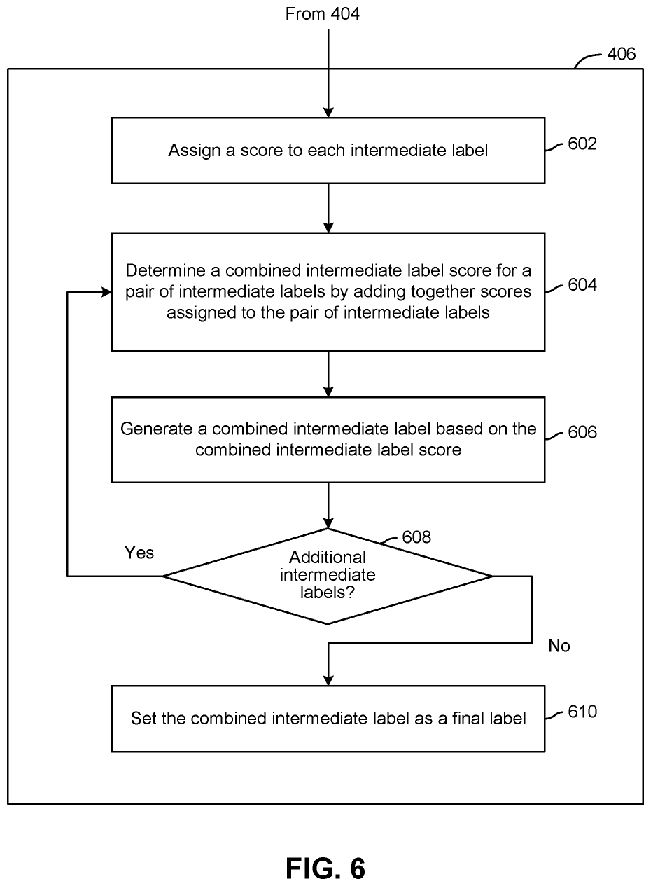

At step 406, the segmentation application 104 generates a final label (e.g., final label 360) based on a combination of the intermediate labels. In some embodiments, the segmentation application 104 generates the final label based on pairwise combinations of intermediate labels, as discussed in greater detail below in conjunction with FIG. 6. Once generated, the final label can be used in any technically feasible manner. For example, the final label could be added to a profile of the user that is stored in a database and displayed to a sender of the messages (e.g., a sender of messages associated with a particular brand). As another example, the final label could be used to generate new messages to send to the user and/or to determine additional messages to send to the user.

FIG. 5 illustrates a flow diagram of method steps for normalizing the set of events at step 404, according to various embodiments. Although the method steps are described in conjunction with the systems of FIGS. 1-3, persons of ordinary skill in the art will understand that any system configured to perform the method steps, in any order, is within the scope of the present disclosure.

As shown, at step 502, the segmentation application 104 applies a time decay to events in the set of events that accounts for messaging cadence to determine a decayed count of the events (e.g., decayed event count 312). In some embodiments, the decayed event count can be computed by assigning a weight to each event and adding the weights together according to equation (2), as described above in conjunction with FIG. 3.

At step 504, the segmentation application 104 computes a raw score (e.g., raw score 322) based on the decayed event count. In some embodiments, the raw score can be computed by dividing the decayed event count by a decayed count of message sends according to equation (3), as described above in conjunction with FIG. 3.

At step 506, the segmentation application 104 adjusts the raw score based on messaging volume to determine an adjusted score (e.g., adjusted score 322). In some embodiments, the raw score can be adjusted by a boosting factor that increases the raw score if the number of events associated with the user is higher relative to a median number of events, according to equations (4)-(5), as described above in conjunction with FIG. 3.

At step 508, the segmentation application 104 converts the adjusted score to an intermediate label (e.g., intermediate label 342). In some embodiments, the segmentation application 104 can assign an intermediate label based on the adjusted score and a histogram of adjusted scores for a given industry. In such cases, a certain percentage of adjusted scores within the histogram can be associated with one label, another percentage of adjusted scores within the histogram can be associated with another label, etc. As described, in the example of brand affinity, a histogram of adjusted scores can be constructed across brands for a given industry, and an intermediate label can be assigned based on an adjusted score and the histogram, with the following label populations: negative: 10%, neutral: 40%, positive: 40%, loyal: 10%, or any other suitable label populations.

FIG. 6 illustrates a flow diagram of method steps for generating the final label based on a combination of intermediate labels at step 406, according to various embodiments. Although the method steps are described in conjunction with the systems of FIGS. 1-3, persons of ordinary skill in the art will understand that any system configured to perform the method steps, in any order, is within the scope of the present disclosure.

As shown, at step 602, the segmentation application 104 assigns scores to each of the intermediate labels. As described, in the example of brand affinity, the following scores could be assigned to intermediate labels: negative=1, neutral=3, positive=7, loyal=11, unscored=0. More generally, any suitable scores can be assigned to intermediate labels in some embodiments.

At step 604, the segmentation application 104 determines a combined intermediate label score for a pair of intermediate labels by adding together the scores assigned to the pair of intermediate labels.

At step 606, the segmentation application 104 generates a combined intermediate label based on the combined intermediate label score. Continuing the brand affinity example from above, a combined label score can be used to generate a combined intermediate label as follows: combined_label_score>=11→loyal, combined_label_score>=7→positive, combined_label_score>=3→neutral, combined_label_score<3→negative.

At step 608, if there are additional intermediate labels, then the method 400 returns to step 604, where the segmentation application 104 determines another combined intermediate label score based on a label score for the combined intermediate label and a label score for another intermediate label from the additional intermediate labels. On the other hand, if there are no additional intermediate labels, then the segmentation application 104 sets the combined intermediate label as the final label at step 610.

In sum, techniques are disclosed for segmenting users based on user interactions with messages transmitted over various electronic communication channels. In some embodiments, a segmentation application normalizes sets of event data associated with user interactions with messages that are transmitted over multiple electronic communication channels to generate intermediate labels associated with the sets of event data. The normalization includes applying a time decay while accounting for messaging cadence, messaging volume, and user interactions with messages associated with an industry. The intermediate labels are combined to generate a final label associated with the user via a pairwise combination technique that maintains a more favorable label when a pair of intermediate labels are combined. Additional messages can then be generated and/or transmitted based on the final label.

One advantage of the techniques disclosed herein is that the disclosed techniques normalize disparate forms of data associated with user interactions with messages that are transmitted over multiple electronic communication channels. The normalization permits users to be segmented into groups, without penalizing the number or type of electronic communication channels over which the messages are transmitted. In addition to being agnostic to the electronic communication channels that are used to transmit messages, the disclosed techniques are scalable when the number of electronic communication channels over which messages are transmitted increases. These technical advantages represent one or more technological improvements over prior art approaches.

1. In some embodiments, a computer-implemented method comprises transmitting a first plurality of messages to a user via an electronic communication channel, storing one or more events associated with one or more interactions of the user with the first plurality of messages, and generating a first label based on the one or more events, wherein generating the first label comprises performing one or more normalization operations based on the one or more events, a time decay, and a time interval between transmission of consecutive messages in the first plurality of messages.

2. The computer-implemented method of clause 1, further comprising transmitting a second plurality of messages to the user via another electronic communication channel, storing one or more additional events associated with one or more interactions of the user with the second plurality of messages, generating a second label based on the one or more additional events, wherein generating the second label comprises performing one or more normalization operations based on the one or more additional events, a time decay, and a time interval between transmission of consecutive messages in the second plurality of messages, and generating a combined label based on the first label and the second label.

3. The computer-implemented method of clauses 1 or 2, wherein generating the combined label comprises adding a first score associated with the first label to a second score associated with the second label to determine a combined score, and determining the combined label based on the combined score.

4. The computer-implemented method of any of clauses 1-3, wherein generating the first label further comprises performing one or more normalization operations based on a number of the first plurality of messages.

5. The computer-implemented method of any of clauses 1-4, wherein the first plurality of messages are associated with an industry, and generating the first label further comprises performing one or more normalization operations based on one or more events associated with interactions of a plurality of users with a plurality of messages associated with the industry.

6. The computer-implemented method of any of clauses 1-5, wherein the one or more events are associated with at least one of the user opening an email, viewing a text message, viewing an in-application notification, viewing a push notification, viewing a web push notification, activating a hyperlink.

7. The computer-implemented method of any of clauses 1-6, further comprising generating a second label based on one or more additional events, wherein generating the second label comprises performing one or more normalization operations based on the one or more additional events, a time decay, and a time interval between consecutive events in the one or more additional events, and generating a combined label based on the first label and the second label.

8. The computer-implemented method of any of clauses 1-7, further comprising receiving one or more additional events associated with at least one of the user making a subscription, viewing a page, viewing a product, adding to a cart, making a purchase, sending a transactional message, or playing a media content item, generating a second label based on the one or more additional events, and generating a combined label based on the first label and the second label.

9. The computer-implemented method of any of clauses 1-8, wherein the first plurality of messages are associated with a brand, and the first label indicates an affinity of the user for the brand.

10. The computer-implemented method of any of clauses 1-9, further comprising generating a new message based on the first label, and transmitting the new message to the user.

11. In some embodiments, one or more non-transitory computer-readable storage media include instructions that, when executed by at least one processor, cause the at least one processor to perform steps comprising transmitting a first plurality of messages to a user via an electronic communication channel, storing one or more events associated with one or more interactions of the user with the first plurality of messages, and generating a first label based on the one or more events, wherein generating the first label comprises performing one or more normalization operations based on the one or more events, a time decay, and a time interval between transmission of consecutive messages in the first plurality of messages.

12.The one or more non-transitory computer-readable storage media of clause 11, wherein the instructions, when executed by at the least one processor, further cause the at least one processor to perform steps comprising transmitting a second plurality of messages to the user via another electronic communication channel, storing one or more additional events associated with one or more interactions of the user with the second plurality of messages, generating a second label based on the one or more additional events, wherein generating the second label comprises performing one or more normalization operations based on the one or more additional events, a time decay, and a time interval between transmission of consecutive messages in the second plurality of messages, and generating a combined label based on the first label and the second label, wherein generating the combined label comprises adding a first score associated with the first label to a second score associated with the second label to determine a combined score, and determining the combined label based on the combined score

13.The one or more non-transitory computer-readable storage media of clauses 11 or 12, wherein generating the first label further comprises performing one or more normalization operations based on a number of the first plurality of messages.

14.The one or more non-transitory computer-readable storage media of any of clauses 11-13, wherein the first plurality of messages are associated with an industry, and generating the first label further comprises performing one or more normalization operations based on one or more events associated with interactions of a plurality of users with a plurality of messages associated with the industry.

15. The one or more non-transitory computer-readable storage media of any of clauses 11-14, wherein the one or more events are associated with at least one of the user opening an email, viewing a text message, viewing an in-application notification, viewing a push notification, viewing a web push notification, or activating a hyperlink.

16. The one or more non-transitory computer-readable storage media of any of clauses 11-15, wherein the instructions, when executed by at the least one processor, further cause the at least one processor to perform steps comprising generating a second label based on one or more additional events, wherein generating the second label comprises performing one or more normalization operations based on the one or more additional events, a time decay, and a time interval between consecutive events in the one or more additional events, and generating a combined label based on the first label and the second label.

17. The one or more non-transitory computer-readable storage media of any of clauses 11-16, wherein the instructions, when executed by at the least one processor, further cause the at least one processor to perform steps comprising receiving one or more additional events associated with at least one of the user making a subscription, viewing a page, viewing a product, adding to a cart, making a purchase, sending a transactional message, or playing a media content item, generating a second label based on the one or more additional events, and generating a combined label based on the first label and the second label.

18. The one or more non-transitory computer-readable storage media of any of clauses 11-17, wherein the first plurality of messages are associated with a brand, and the first label indicates one of loyal, positive, neutral, or negative affinity towards the brand.

19. In some embodiments, a system comprises one or more memories storing instructions, and one or more processors that are coupled to the one or more memories and, when executing the instructions, are configured to transmit a first plurality of messages to a user via an electronic communication channel, store one or more events associated with one or more interactions of the user with the first plurality of messages, and generate a first label based on the one or more events, wherein generating the first label comprises performing one or more normalization operations based on the one or more events, a time decay, and a time interval between transmission of consecutive messages in the first plurality of messages.

20. The system of clause 19, wherein the one or more processors, when executing the instructions, are further configured to transmit a second plurality of messages to the user via another electronic communication channel, store one or more additional events associated with one or more interactions of the user with the second plurality of messages, generate a second label based on the one or more additional events, wherein generating the second label comprises performing one or more normalization operations based on the one or more additional events, a time decay, and a time interval between transmission of consecutive messages in the second plurality of messages, and generate a combined label based on the first label and the second label.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
transmitting a first plurality of messages to a user via an electronic communication channel;
storing one or more events associated with one or more interactions of the user with the first plurality of messages; and
generating a first label based on the one or more events, wherein generating the first label comprises performing one or more normalization operations based on the one or more events, a time decay, and a time interval between transmission of consecutive messages in the first plurality of messages.

2. The computer-implemented method of claim 1, further comprising:
transmitting a second plurality of messages to the user via another electronic communication channel;
storing one or more additional events associated with one or more interactions of the user with the second plurality of messages;
generating a second label based on the one or more additional events, wherein generating the second label comprises performing one or more normalization operations based on the one or more additional events, a time decay, and a time interval between transmission of consecutive messages in the second plurality of messages; and
generating a combined label based on the first label and the second label.

3. The computer-implemented method of claim 2, wherein generating the combined label comprises:
adding a first score associated with the first label to a second score associated with the second label to determine a combined score; and
determining the combined label based on the combined score.

4. The computer-implemented method of claim 1, wherein generating the first label further comprises performing one or more normalization operations based on a number of the first plurality of messages.

5. The computer-implemented method of claim 1, wherein the first plurality of messages are associated with an industry, and generating the first label further comprises performing one or more normalization operations based on one or more events associated with interactions of a plurality of users with a plurality of messages associated with the industry.

6. The computer-implemented method of claim 1, wherein the one or more events are associated with at least one of the user opening an email, viewing a text message, viewing an in-application notification, viewing a push notification, viewing a web push notification, or activating a hyperlink.

7. The computer-implemented method of claim 1, further comprising:
generating a second label based on one or more additional events, wherein generating the second label comprises performing one or more normalization operations based on the one or more additional events, a time decay, and a time interval between consecutive events in the one or more additional events; and
generating a combined label based on the first label and the second label.

8. The computer-implemented method of claim 1, further comprising:
receiving one or more additional events associated with at least one of the user making a subscription, viewing a page, viewing a product, adding to a cart, making a purchase, sending a transactional message, or playing a media content item;
generating a second label based on the one or more additional events; and
generating a combined label based on the first label and the second label.

9. The computer-implemented method of claim 1, wherein the first plurality of messages are associated with a brand, and the first label indicates an affinity of the user for the brand.

10. The computer-implemented method of claim 1, further comprising:
generating a new message based on the first label; and
transmitting the new message to the user.

11. One or more non-transitory computer-readable storage media including instructions that, when executed by at least one processor, cause the at least one processor to perform steps comprising:
transmitting a first plurality of messages to a user via an electronic communication channel;
storing one or more events associated with one or more interactions of the user with the first plurality of messages; and
generating a first label based on the one or more events, wherein generating the first label comprises performing one or more normalization operations based on the one or more events, a time decay, and a time interval between transmission of consecutive messages in the first plurality of messages.

12. The one or more non-transitory computer-readable storage media of claim 11, wherein the instructions, when executed by at the least one processor, further cause the at least one processor to perform steps comprising:
transmitting a second plurality of messages to the user via another electronic communication channel;
storing one or more additional events associated with one or more interactions of the user with the second plurality of messages;
generating a second label based on the one or more additional events, wherein generating the second label comprises performing one or more normalization operations based on the one or more additional events, a time decay, and a time interval between transmission of consecutive messages in the second plurality of messages; and
generating a combined label based on the first label and the second label, wherein generating the combined label comprises:
adding a first score associated with the first label to a second score associated with the second label to determine a combined score, and
determining the combined label based on the combined score

13. The one or more non-transitory computer-readable storage media of claim 11, wherein generating the first label further comprises performing one or more normalization operations based on a number of the first plurality of messages.

14. The one or more non-transitory computer-readable storage media of claim 11, wherein the first plurality of messages are associated with an industry, and generating the first label further comprises performing one or more normalization operations based on one or more events associated with interactions of a plurality of users with a plurality of messages associated with the industry.

15. The one or more non-transitory computer-readable storage media of claim 11, wherein the one or more events are associated with at least one of the user opening an email, viewing a text message, viewing an in-application notification, viewing a push notification, viewing a web push notification, or activating a hyperlink.

16. The one or more non-transitory computer-readable storage media of claim 11, wherein the instructions, when executed by at the least one processor, further cause the at least one processor to perform steps comprising:
generating a second label based on one or more additional events, wherein generating the second label comprises performing one or more normalization operations based on the one or more additional events, a time decay, and a time interval between consecutive events in the one or more additional events; and
generating a combined label based on the first label and the second label.

17. The one or more non-transitory computer-readable storage media of claim 11, wherein the instructions, when executed by at the least one processor, further cause the at least one processor to perform steps comprising:
receiving one or more additional events associated with at least one of the user making a subscription, viewing a page, viewing a product, adding to a cart, making a purchase, sending a transactional message, or playing a media content item;
generating a second label based on the one or more additional events; and
generating a combined label based on the first label and the second label.

18. The one or more non-transitory computer-readable storage media of claim 11, wherein the first plurality of messages are associated with a brand, and the first label indicates one of loyal, positive, neutral, or negative affinity towards the brand.

19. A system, comprising:
one or more memories storing instructions; and
one or more processors that are coupled to the one or more memories and, when executing the instructions, are configured to:
transmit a first plurality of messages to a user via an electronic communication channel,
store one or more events associated with one or more interactions of the user with the first plurality of messages, and
generate a first label based on the one or more events, wherein generating the first label comprises performing one or more normalization operations based on the one or more events, a time decay, and a time interval between transmission of consecutive messages in the first plurality of messages.

20. The system of claim 19, wherein the one or more processors, when executing the instructions, are further configured to:
transmit a second plurality of messages to the user via another electronic communication channel;
store one or more additional events associated with one or more interactions of the user with the second plurality of messages;
generate a second label based on the one or more additional events, wherein generating the second label comprises performing one or more normalization operations based on the one or more additional events, a time decay, and a time interval between transmission of consecutive messages in the second plurality of messages; and
generate a combined label based on the first label and the second label.
